(19) United States
(12) Patent Application Publication
(10) Pub. No.: US 2024/0223878 A1
(43) Pub. Date: Jul. 4, 2024

(54) CRACKING IMAGE INSPECTION SYSTEM AND METHOD

(71) Applicant: Nippon Telegraph and Telephone Corporation, Tokyo (JP)

(72) Inventors: Yurina Tanaka, Tokyo (JP); Yuichi Akage, Tokyo (JP); Soichi Oka, Tokyo (JP)

(21) Appl. No.: 18/561,959

(22) PCT Filed: May 26, 2021
(86) PCT No.: PCT/JP2021/019974

§ 371 Date: Nov. 17, 2023

(51) Int. Cl. H04N 23/56; G06T 7/00; G06T 7/60

(52) U.S. Cl. CPC H04N 23/56; G06T 7/0002; G06T 7/60; G06T 2207/30184; G06T 2207/30242

(57) ABSTRACT

A laser emitting device includes a projection lens whose focal length is known and a laser, is fixed to a digital camera, and emits a laser beam focused by the projection lens in a photographing direction of the digital camera. A counting device counts the number of pixels of a portion of a projection image in a projected image obtained by capturing, with the digital camera, the projection image of the laser beam emitted by the laser emitting device and projected on a target surface. The number of pixels counted by the counting device is displayed on a display device, for example.

### CROSS-REFERENCE TO RELATED APPLICATIONS

This application is a national phase entry of PCT Application No. PCT/JP2021/019974, filed on May 26, 2021, which application is hereby incorporated herein by reference.

### TECHNICAL FIELD

The present invention relates to a crack image inspection system and method.

### BACKGROUND

In general, inspection of reinforced concrete structures is performed by crack measurement. This is because rain or the like enters from a cracked portion, and corrosion of the reinforcing bar progresses. As this type of crack measurement, a technique has been devised for identifying an actual crack by image processing (see Patent Literature 1). As an investigation item related to cracking of a concrete surface, there is a width of a crack (crack width). The crack width is measured by comparison with crack scale. Conventionally, since this measurement is performed manually, there has been a problem that a lot of inspection time is required and variation occurs among workers.

For the above-described problem, in recent years, a technique has been devised for calculating a crack width from an image obtained by imaging a structure. In this technique, an image of a portion of a crack of a structure is captured, and the width of the crack is calculated from the number of pixels of the portion of the crack in the obtained image. To calculate the crack width, for example, a reference having a known size is arranged next to the portion of the crack and imaged, and the number of pixels of a portion of the reference in the obtained image is counted to convert the length of one pixel. A coefficient used in this conversion for converting one pixel into a length is called resolution, and it is necessary to calculate the resolution to calculate the crack width from the image.

### CITATION LIST

### Patent Literature

Patent Literature 1: Japanese Patent No. 5385593

### SUMMARY

### Technical Problem

However, in the conventional technique, a ruler or the like is often added as a reference, and it requires a lot of effort and time to add the reference each time an enormous area is photographed. In addition, there is a case where a part (a pipe, a screw, or the like) included in a structure is used as the reference. In this case, it is not necessary to perform photographing with the reference, but it is necessary to perform photographing from the front. However, adjustment of a photographing angle of a camera often depends on a photographer, and in a case where photographing cannot be performed perpendicularly to the reference, there is a possibility that an actual distance differs depending on a pixel.

Embodiments of the present invention have been made to solve the above problems, and an object of embodiments of the present invention is to enable a crack image to be captured so that a correspondence between the pixel and the actual distance is constant.

### Solution to Problem

A crack image inspection system according to embodiments of the present invention includes: a digital camera; a laser emitting device that includes a projection lens whose focal length is known and a laser and is fixed to the digital camera, the laser emitting device emitting a laser beam focused by the projection lens in a photographing direction of the digital camera; and a counting device that counts the number of pixels of a portion of a projection image in a projected image obtained by capturing, with the digital camera, the projection image of the laser beam emitted by the laser emitting device and projected on a target surface, in which the focal length of the projection lens has a value obtained from a relationship between a dimension of one pixel of an imaging element of the digital camera and a length on an image captured by the digital camera.

In addition, a crack image inspection method according to embodiments of the present invention includes: a first step of emitting, with a laser emitting device that includes a projection lens whose focal length is known and a laser and is fixed to a digital camera, a laser beam focused by the projection lens in a photographing direction of the digital camera; a second step of capturing, with the digital camera, a projection image of the laser beam emitted by the laser emitting device and projected on a target surface; and a third step of counting the number of pixels of a portion of the projection image in a projected image captured by the digital camera, in which the focal length of the projection lens has a value obtained from a relationship between a dimension of one pixel of an imaging element of the digital camera and a length on an image captured by the digital camera.

### Advantageous Effects

As described above, according to embodiments of the present invention, since the number of pixels of the portion of the projection image in the projected image obtained by capturing the projection image of the laser beam with the digital camera is counted, a crack image can be captured so that the correspondence between the pixel and the actual distance is constant.

### BRIEF DESCRIPTION OF THE DRAWINGS

FIG. 1 is a configuration diagram illustrating a configuration of a crack image inspection system according to an embodiment of the present invention.

FIG. 2 is a flowchart for explaining a crack image inspection method according to the embodiment of the present invention.

FIG. 3 is a configuration diagram illustrating a hardware configuration of the crack image inspection system according to the embodiment of the present invention.

### DETAILED DESCRIPTION OF ILLUSTRATIVE EMBODIMENTS

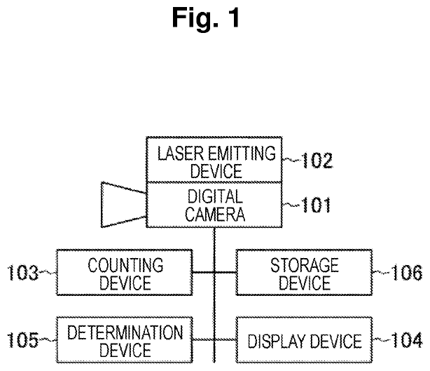

Hereinafter, a crack image inspection system according to an embodiment of the present invention will be described with reference to FIG. 1. The crack image inspection system includes a digital camera 101, a laser emitting device 102, a counting device 103, and a display device 104.

The digital camera 101 includes an area image sensor (solid-state imaging element) as a light receiving unit. The laser emitting device 102 includes a projection lens (objective lens) whose focal length is known and a laser, is fixed to the digital camera 101, and emits a laser beam focused by the projection lens in a photographing direction of the digital camera 101. The laser emitting device 102 is fixed to the digital camera 101 such that a point that serves as a reference of the focal length of the projection lens coincides with a light receiving surface of the imaging element of the digital camera 101. The focal length of the projection lens has a value obtained from a relationship between a dimension of one pixel of the imaging element of the digital camera 101 and a length on an image captured by the digital camera 101.

The counting device 103 counts the number of pixels of a portion of a projection image in a projected image obtained by capturing, with the digital camera 101, the projection image of the laser beam emitted by the laser emitting device 102 and projected on a target surface. The number of pixels counted by the counting device 103 is displayed on the display device 104, for example.

Size (for example, beam diameter) of the projection image of the laser beam emitted by the laser emitting device 102 and projected on the target surface varies depending on a difference from the focal length of the projection lens. When a distance to a projection surface on which the projection image is formed is equal to the focal length of the projection lens, the beam diameter is minimized.

Corresponding to a change in the size (beam diameter) of the projection image described above, the number of pixels displayed on the display device 104 changes when a distance from the digital camera 101 (laser emitting device 102) to the target surface is changed. When the distance from the digital camera 101 (laser emitting device 102) to the target surface is equal to the focal length of the projection lens described above, the number of pixels displayed is minimized.

Here, for example, it is known that when a laser beam that is collimated light having a beam diameter D passes through a single lens, the laser beam is focused at a distance of a focal point f indicated by “d=fλ/(πD)” with a beam diameter d. The λ is a wavelength of the laser beam. As can be seen from this equation, a beam spot having a size d appears at a distance f from the lens (projection lens), and the beam diameter and the distance from the lens are constant as long as the lens is not changed.

The digital camera 101 is arranged at the distance of the focal point f, and an image is captured to include the beam spot. The image can be used as a calibration image, and the number of pixels of the beam spot of the calibration image can be counted and used as a reference number of pixels. In addition, resolution (coefficient for converting one pixel into a length) can be calculated from the reference number of pixels and the beam diameter of the beam spot. By using the resolution, the length of one pixel of the captured image can be obtained, and a width of a crack captured can be obtained.

In addition, the crack image inspection system according to the embodiment can include a determination device 105 that determines whether or not the number of pixels counted by the counting device 103 falls within a range of the reference and outputs a determination result. When it is determined that the number of pixels counted by the counting device 103 falls within the range of the reference, the determination device 105 stores the image captured by the digital camera 101 in a storage device 106.

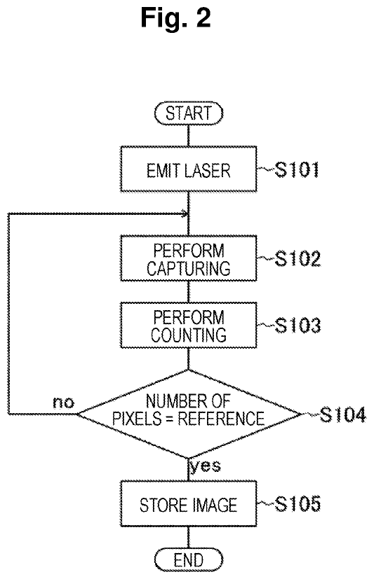

Next, a crack image inspection method according to the embodiment of the present invention will be described with reference to FIG. 2.

First, a position of the digital camera 101 is adjusted so that the inspection point falls within an angle of view. For example, a state is set in which the lens of the digital camera 101 activated is directed to the inspection point, and the inspection point is in an imaging range by using a liquid crystal monitor or the like of the digital camera 101.

Subsequently, in a first step S101, the laser emitting device 102 that includes the projection lens whose focal length is known and the laser and is fixed to the digital camera 101 emits the laser beam focused by the projection lens in the photographing direction of the digital camera 101. The focal length of the projection lens has a value obtained from a relationship between a dimension of one pixel of the imaging element of the digital camera 101 and a length on an image captured by the digital camera 101.

Next, in a second step S102, the digital camera 101 captures a projection image of the laser beam emitted by the laser emitting device 102 and projected on the target surface. Subsequently, in a third step S103, the number of pixels of a portion of the projection image in a projected image captured by the digital camera 101 is counted. The number of pixels counted is displayed on the display device 104 and is visible to an inspector.

Next, in a fourth step S104, it is determined whether or not the number of pixels counted in the third step S103 falls within the range of the reference. When it is determined that the number of pixels counted in the fourth step S104 falls within the range of the reference (yes in the fourth step S104), the image captured by the digital camera 101 is stored in the storage device 106 in a fifth step S105. For example, when a shutter button of the digital camera 101 is pressed (a shutter is released) in a state determined as described above, the image displayed on the liquid crystal monitor is stored in the storage device 106. The above-described determination is performed by the determination device 105, and the determination device 105 can release the shutter of the digital camera 101 in a case where the number of pixels counted reaches a reference value.

The laser emitting device 102 is fixed to the digital camera 101, and the laser emitting device 102 also moves at the same time according to movement of the digital camera 101. When the digital camera 101 is moved closer to or away from a target surface of a measurement target, the beam diameter of the laser beam emitted to the target surface varies depending on a difference from the focal length of the projection lens. When the digital camera 101 is arranged at a position of the focal length of the projection lens, the laser emitting device 102 is also adjusted to the position of the focal length of the projection lens, and the beam diameter of the beam projected on the target surface is minimized. The positions of the digital camera 101 and the measurement target are adjusted so that the beam diameter is minimized. The reference value (the range of the reference) described above can be determined by counting the number of pixels occupied by the projection image in an image captured in this state.

After the reference is determined as described above, in capturing a crack image for inspection, the digital camera 101 is arranged such that the number of pixels of the projection image of the laser beam projected on the target surface falls within the range of the reference, and a captured image is stored in the storage device 106. For example, the shutter button is pressed by the inspector, whereby it is possible to store the captured image in the storage device 106. In addition, by operation of the determination device 105 described above, it is also possible to automatically release the shutter of the digital camera 101.

The inspector can acquire an inspection image only by adjusting the position of the digital camera 101 back and forth with respect to the target surface. Inspection work can be completed by performing these on the entire inspection point. In a plurality of inspection images acquired by performing these on the entire inspection point, distances between an inspection target and the digital camera 101 can be made uniform, and the resolution calibrated in advance can be applied to all inspection results.

By the way, by configuring the projection lens of the laser emitting device 102 with a diffractive optical element (DOE), a spatial light modulator, or the like, it is possible to make a projection image any shape such as a rectangle or a character. As a result, it is possible to use not only the number of pixels but also a shape (pixel arrangement) of the projection image captured can be used for adjustment of a photographing position, so that adjustment of the photographing position can be performed more easily.

In addition, the laser emitting device 102 (the first step S101) can emit a plurality of laser beams. For example, two laser beams, upper and lower, are emitted to the ground, and two projection images are projected on a target surface of crack measurement (inspection). The two projection images projected in this manner are captured by the digital camera 101, and the number of pixels of each projection image is counted.

For example, in a case where a photographing angle of the digital camera 101 is a so-called low angle or high angle, a state is obtained in which the numbers of pixels of the two projection images, upper and lower, are different from each other. In this state, even if the number of pixels on one projection image falls within the range of the reference, the number of pixels on the other projection image is out of the reference. On the other hand, if the photographing angle is a horizontal angle, a state is obtained in which the numbers of pixels of both simultaneously falls within the range of the reference. As described above, by emitting the plurality of laser beams, it is possible to adjust an angle with respect to the target surface such as an angle of the digital camera 101.

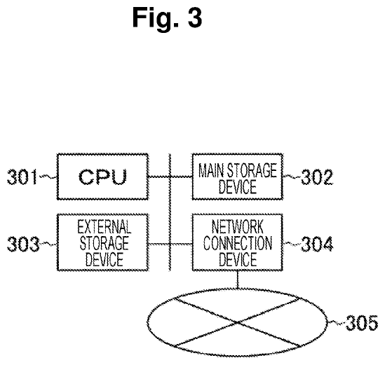

Note that, as illustrated in FIG. 3, the counting device, the determination device, and the storage device of the crack image inspection system according to the above-described embodiment can implement functions (crack image inspection method) described above by forming a computer device including a central processing unit (CPU) 301, a main storage device 302, an external storage device 303, a network connection device 304, and the like, and causing the CPU 301 to operate according to a program deployed in the main storage device 302 (execute the program). The program is a program for a computer to execute the crack image inspection method described in the above-described embodiment. The network connection device 304 is connected to a network 305. In addition, the functions can be distributed to a plurality of computer devices.

As described above, according to embodiments of the present invention, since the number of pixels is counted of the portion of the projection image in the projected image obtained by capturing the projection image of the laser beam with the digital camera, it is possible to capture a crack image so that the correspondence between the pixel and the actual distance is constant. According to embodiments of the present invention, it is possible to perform inspection without requiring a lot of inspection time and without causing variation among workers. According to embodiments of the present invention, it is not necessary to add a ruler or the like as a reference, and it does not require a lot of effort or time.

Note that the present invention is not limited to the embodiment described above, and it is obvious that many modifications and combinations can be made by those skilled in the art within the technical idea of the present invention.

### REFERENCE SIGNS LIST

101 digital camera
102 laser emitting device
103 counting device
104 display device
105 determination device
106 storage device

1-8. (canceled)

9. A system comprising:
a digital camera;
a laser emitting device comprising a projection lens with a known focal length and a laser fixed to the digital camera, the laser emitting device is configured to emit a laser beam focused by the projection lens in a photographing direction of the digital camera; and
one or more processors; and
a storage device storing a program to be executed by the one or more processors, the program including instructions to:
count a number of pixels of a portion of a projection image in a projected image, wherein the projected image is obtained by capturing, with the digital camera, the projection image of the laser beam emitted by the laser emitting device and projected on a target surface, and wherein the known focal length of the projection lens has a value obtained from a relationship between a dimension of one pixel of an imaging element of the digital camera and a length on an image captured by the digital camera.

10. The system according to claim 9, wherein the program includes further instructions to:
determine whether the number of pixels counted falls within a range of a reference; and
outputs a determination result of whether the number of pixels counted falls within the range of the reference.

11. The system according to claim 10, wherein the program includes further instructions to:
when it is determined that the number of pixels counted falls within the range of the reference, store the projected image captured by the digital camera in the storage device.

12. The system according to claim 9, wherein
the laser emitting device is configured to emit a plurality of the laser beams.

13. The system according to claim 9, further comprising:
a display device configured to display the number of pixels counted.

14. The system according to claim 9, wherein the program includes further instructions to:
determine a resolution of the projected image captured by the digital camera based on the number of pixels counted; and
determine a size of a crack in the projected image based on the resolution of the projected image.

15. A method comprising:
a first step of emitting, with a laser emitting device comprising a projection lens with a known focal length and a laser and is fixed to a digital camera, a laser beam focused by the projection lens in a photographing direction of the digital camera;
a second step of capturing, in an projected image with the digital camera, a projection image of the laser beam emitted by the laser emitting device and projected on a target surface; and
a third step of counting a number of pixels of a portion of the projection image in the projected image captured by the digital camera, wherein the known focal length of the projection lens has a value obtained from a relationship between a dimension of one pixel of an imaging element of the digital camera and a length on an image captured by the digital camera.

16. The method according to claim 15, further comprising:
a fourth step of determining whether the number of pixels counted in the third step falls within a range of a reference.

17. The method according to claim 16, further comprising:
a fifth step of storing the projected image captured by the digital camera in a storage device when it is determined that the number of pixels counted in the fourth step falls within the range of the reference.

18. The method according to claim 15, wherein
in the first step, a plurality of the laser beams is emitted.

19. The method according to claim 15, further comprising:
a sixth step of displaying, on a display device, the number of pixels counted in the third step.

20. The method according to claim 15, further comprising:
a seventh step of determining a resolution of the projected image captured by the digital camera based on the number of pixels counted in the third step; and
an eighth step of determining a size of a crack in the projected image based on the resolution of the projected image.
